(19) United States
(12) Patent Application Publication
(10) Pub. No.: US 2026/0349700 A1
(43) Pub. Date: Nov. 5, 2026

(54) INTELLIGENT RANKING OF PRE-UPDATE ISSUES AT SCALE

(71) Applicant: Red Hat, Inc., Raleigh, NC (US)

(72) Inventors: Tomas Meszaros, Brno (CZ); Paolo Antinori, Milan (IT)

(21) Appl. No.: 19/195,021

(22) Filed: Apr. 30, 2025

(51) Int. Cl. G06F 8/65

(52) U.S. Cl. CPC G06F 8/65

(57) ABSTRACT

A system and method including receiving a request for information indicating an updatability of a plurality of software applications executing on a plurality of client devices to a particular version. The method includes predicting a plurality of issues associated with an update of the plurality of software applications to the particular version prior to performing the update. The method includes classifying the plurality of issues into a plurality of issue groups. The method includes generating a plurality of scores respectively associated with the plurality of issue groups. The method includes ranking the plurality of issue groups based on the plurality of scores.

### TECHNICAL FIELD

The present disclosure relates to data processing, and more particularly, to systems and methods of a pre-update issue ranking (PUIR) system that intelligently predicts and ranks pre-update issues associated with downgrading or upgrading computer programs at scale.

### BACKGROUND

Network administrators manage software running on client devices within a network to ensure smooth and secure operations. They oversee the installation, configuration, and maintenance of software applications, ensuring compatibility and performance. Admins are responsible for deploying software updates, which include security patches, bug fixes, and new features, to keep systems up-to-date and protected against vulnerabilities. They use various tools and techniques, such as remote management software, to distribute updates across multiple devices. Regular monitoring and testing help to identify potential issues and verify that updates are successfully applied. By managing software and updates, admins help maintain the overall health and security of the network.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for intelligently predicts and ranks pre-update issues associated with downgrading or upgrading computer programs at scale, according to some embodiments;

FIG. 2A is a block diagram depicting an example of the pre-upgrade issue ranking (PUIR) system of the environment in FIG. 1, according to some embodiments;

FIG. 2B is a block diagram depicting an example of the admin device in FIG. 1, according to some embodiments;

FIG. 2C is a block diagram depicting an example environment for using the PUIR system in FIG. 1, according to some embodiments;

FIG. 3 is a flow diagram depicting a method of intelligently predicting and ranking pre-update issues associated with downgrading or upgrading computer programs at scale, according to some embodiments; and

FIG. 4 is a block diagram of an example computing device that may perform one or more of the operations described herein, in accordance with some embodiments.

### DETAILED DESCRIPTION

An administrator in charge of a computing network that includes hundreds or thousands of computing devices, such as a big RHEL deployment at large a company, a fleet of edge devices, or systems in automotive applications, might explore the option to in-place upgrade to the next major version at some point in an operating system (OS) lifecycle (e.g., RHEL 7 to RHEL 8). The challenge with in-place upgrading to the next major version of the operating system is that there might a big technical drift exists between the versions of the operating systems. That is, the next version could be much different from the older version. For example, some subsystems of the operating system might be incompatible with the new versions (e.g., big differences in networking or storage subsystems), or the new version might not support older hardware that the older OS version supports. This creates a risk for the administrators, who demand specialized tooling to discover all the potential issues related to in-place upgrades from one major version to another.

The specialized tooling often implements some pre-upgrade analysis capabilities, which can analyze the system and report back to the user various issues that can degrade the in-place upgrade or completely block it. Administrators can study these pre-upgrade reports and decide on the next steps, such as fixing the issues and in-place upgrade or reinstalling the software on the computing devices. This workflow might work well for fleets that do not contain many computing devices.

However, for fleets of thousands or even tens of thousands of computing devices, the administrators are not effectively capable of analyzing thousands of pre-upgrade reports and knowing which computing devices should receive prioritized attention or which issues are the most important to fix. Consequently, the computing devices might experience prolonged downtime, affecting productivity and potentially causing data loss or security vulnerabilities. The vulnerabilities could be exploited by an attacker, resulting in a waste of computing resources (e.g., memory, processing, networking). Additionally, unresolved issues can spread, impacting other computing devices and leading to larger network disruptions. Thus, there is a long-felt but unsolved need for a solution for efficiently distributing software updates across multiple devices without introducing issues that consume excess computing resources, such as processing and memory.

Aspects of the present disclosure address the above-noted and other deficiencies by providing a pre-update issue ranking (PUIR) system that intelligently predicts and ranks pre-update issues associated with downgrading or upgrading computer programs (e.g., software, firmware, drivers, middleware, applications) from one version to another version at scale. The PUIR system ranks the pre-update issues based on several strategies, which allows for effective prioritization when assessing the in-place updateability of fleets containing a large number of client devices (e.g., laptops, desktops, Linux-based systems, smartphones, automotive systems). The PUIR system performs a pre-update analysis on the plurality of client devices of a computing network to produce a plurality of pre-update reports that are respectively associated with the plurality of client devices. The computing network may include hundreds to thousands of client devices, or more. Each pre-update report indicates the one or more issues impacting the updateability (e.g., ability to upgrade, ability to downgrade) of the computer program on the respective client device. These issues can be diverse in nature, for example, incompatible hardware, not enough disk space, wrong configuration of ssh daemon, and/or the like.

The PUIR system includes a collector for constructing, based on the plurality of pre-update reports, a hash table which allows for the classification and grouping of the client devices according to each pre-update issue. The PUIR system also includes a ranking system for generating impact scores for the pre-update issues and ranking the pre-update issues by impact score, for example, from high to low. The ranking system includes a plurality of ranking strategy engines (sometimes referred to as modules) that are respectively configured to use a plurality of sub-algorithms that focus on a specialized aspect of the pre-update assessment. For example, a first engine that is configured to score the issues by security impact might assign higher impact scores to issues that present security risks for the update (e.g., a problematic ssh configuration or SELinux configuration, detection of specific crypto engines that might cause problems on the next OS version, etc.). A second engine that is configured to score the issues by hardware requirements might assign higher impact scores to hardware-related issues (e.g., lack of available disk space, incompatible processor type, lack of available memory). A third engine that is configured to score the issues by specialized domain-specific criteria (e.g., automotive safety integrity level).

The PUIR system provides an administrator with the ability to add a custom ranking strategy engine based on their particular demands. For example, administrators in banks might be interested in systems containing pre-update issues related to firewall configuration. In this case, administrators can supply their own ranking strategy engine which would assign such issues a higher impact score, which would in turn cause those issues to be ranked higher in the final report and thus prioritized.

The ranking strategy executes all ranking strategy engines that are activated and assigns impact scores to individual issues. Issues are then sorted from the highest impact score to the lowest ranked. The final report is created and presented to the administrators, who can effectively prioritize the issues and systems with the highest priority.

In an illustrative embodiment, a PUIR system that intelligently predicts and ranks pre-update issues associated with upgrading or downgrading computer programs at scale. The PUIR system receives a request for information indicating an updatability of a plurality of software applications executing on a plurality of client devices to a particular version. The PUIR system predicts a plurality of issues associated with an update of the plurality of software applications to the particular version prior to performing the update. The PUIR system classifies the plurality of issues into a plurality of issue groups. The PUIR system generates a plurality of scores respectively associated with the plurality of issue groups. The PUIR system ranks the plurality of issue groups based on the plurality of scores.

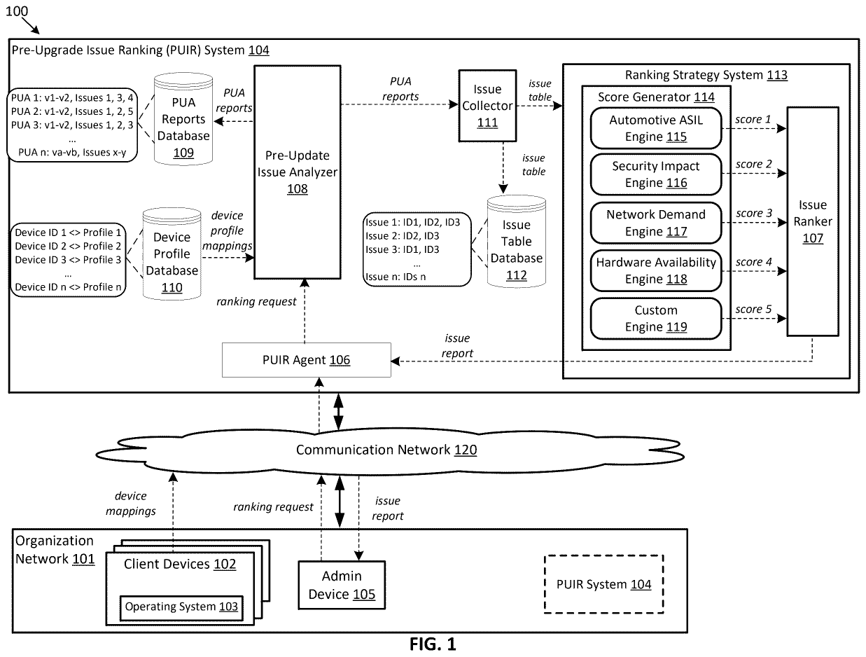

FIG. 1 is a block diagram depicting an example environment for intelligently predicts and ranks pre-update issues associated with downgrading or upgrading computer programs at scale, according to some embodiments. Environment 100 includes a PUIR system 104 and an organization network 101 that are each communicably coupled together via a communication network 120. An organization network may include, for example, a corporation's computing network, a financial institution's computing network, a government agency's computing network, an educational institution's computing network, a private computing network, similar computing networks.

The organization network 101 includes a plurality of client devices 102 that each execute their own operating system 103 (e.g., Linux®, Windows®) for executing one or more software applications. In some embodiments, the organization network 101 may include a large number of clients devices 102, such as hundreds, thousands, tens of thousands of computing devices. Each operating system 103 may executing one or more software applications including, for example, word processing applications, photo editing applications, spreadsheet applications, presentation applications, database management systems, web browsers, email clients, project management tools, graphic design software, video editing software, antivirus software, operating systems, accounting software, cad software, music production software, and or the like.

The organization network 101 also includes an admin device 105 operated by an administrator of the organization network 101. The admin device 105 has permission to send requests (shown in FIG. 1 as ranking request) to the PUIR system 104, where the request is for the PUIR system 104 to make predictions about whether an upgrade or downgrade to a computer program (e.g., operating system 103) running on a set of client devices 102 in the organization network 101 could create issues impacting the performance of the computing resources (e.g., hardware, software) of the set of client device 102. The ranking request includes a target version number of the computer program that the administrator wants to apply to particular set of client device 102 and the device identifiers for the set of client device 102. The PUIR system 104 sends a report back to the admin device 105 indicating a list of issues (ranked from higher priority to lower priority) that are likely to occur for the set of client devices if the admin device 105 upgrades or downgrades the computer program on the set of client devices 102. As discussed herein, an issue may be a hardware-related issue and/or a software-related issue.

The PUIR system 104 executes and/or includes a PUIR agent 106, a pre-update issue analyzer 108, an issue collector 111, and a ranking strategy system 113. The ranking strategy system 113 executes and/or includes a score generator 114 and an issue ranker 107. The score generator 114 includes an Automotive Safety Integrity Level (ASIL) engine 115 configured to score the issues related to automotive safety integrity level caused by the update to a computer program. The score generator 114 includes a security impact engine 116 configured to score the issues related to security risks caused by the update to a computer program (e.g., a problematic ssh configuration or SELinux configuration, detection of specific crypto modules that might cause problems on the next OS version, etc.). The score generator 114 includes a network demand engine 117 configured to score the issues related to networking bandwidth, networking latency, and/or networking traffic caused by the update to a computer program. The score generator 114 includes a hardware availability engine 118 configured to score the hardware-related issues (e.g., lack of available disk space, incompatible processor type, lack of available memory) caused by the update to a computer program. The score generator 114 includes a custom engine 119 configured to score user-defined issues (e.g., as defined by the admin device 105) caused by the update to a computer program.

The PUIR system 104 includes a plurality of databases that are configured to store different datasets. Specifically, the PUIR system 104 includes a device profile database 110 that is configured to store a mapping between a plurality of device identifiers (ID) (e.g., device name, Media Access Control (MAC) address), serial number, network address) and a plurality of device profiles. For example, as shown in FIG. 1, device ID 1 is mapped to device profile 1 for a first client device 102, device ID 2 is mapped to device profile 2 for a second client device 102, and device ID 3 is mapped to device profile 3 for a third client device 102, and so on. A device profile indicates information (e.g., name, version, functional description, capabilities) about the current computing resources of the client device 102, such as the hardware and software of the client device 102. The device profile may also indicate other information, such as a current workload, a current memory usage, a current hardware usage, a current processor usage, a current CPU temperature, a current state of the network adapter, a list of software applications that are currently executing on the computing resource, operating system type and version, etc.

The PUIR system 104 receives the device profiles from the client devices 102 and stores the mappings between the plurality of device IDs and the plurality of device profiles in the device profile database 110. The client devices 102 generate and send revised device profiles to the PUIR system 104 whenever there are changes to the device profile of the client devices 102 to ensure that the PUIR system 104 can stay informed about the current device profiles of the client devices 102.

The PUIR system 104 also includes a PUIR reports database 109 that is configured to store a plurality of pre-update (PUA) reports that are respectively associated with a plurality of client devices 102. Each PUA report indicates the potential issues impacting the performance of the computing resources (e.g., hardware, software) of the client device 102 that could arise if a particular computing program executing on the client device 102 is upgraded or downgraded from one version to another version of the computer program. For example, as shown in FIG. 1, a first PUA report associated with a first client device 102 may indicate that issues 1, 3, and 4 may arise if a particular computer program is upgraded from version 1 to version 2; a second PUA report associated with a second client device 102 may indicate that issues 1, 2, and 5 may arise if a particular computer program is upgraded from version 1 to version 2; and a third PUA report associated with a third client device 102 may indicate that issues 1, 2, and 3 may arise if a particular computer program is upgraded from version 1 to version 2. The computing resources that could be impacted (e.g., degraded) by the upgrade include, for example, memory devices, processing devices, storage devices, networking devices, and or the like.

For example, a particular client device 102 may be executing the latest release of a particular application (e.g., a drawing application, a word processing application, a spreadsheet application) within version 1 of an operating system (OS). In this instance, the PUA report associated with the client device 102 may indicate that upgrading the OS from version 1 to version 2 will prevent the client device 102 from being able to relaunch the particular application within version 2 of the OS because the particular application might not be configured to execute within version 2 of the OS.

The pre-update issue analyzer 108 is configured to generate the PUIR reports based on the device profile mapping data (which is stored in the device profile database 110) and the ranking request. As discussed herein, the ranking request includes a target version number of the computer program that the administrator of the admin device 105 wants to apply to particular set of client device 102 and the device identifiers for the set of client device 102.

Although FIG. 1 shows that the PUIR system 104 stores different dataset in databases, in some embodiments, the PUIR system 104 may store any of these datasets in a local memory of the PUIR system 104 to reduce the time to retrieve the datasets. Thus, as used herein, a dataset may be a collection of data that is organized in a structured format (e.g., in rows and columns) or in an unstructured format that does not have a predefined model or organization.

In some embodiments, each of the components (e.g., PUIR agent 106, pre-update issue analyzer 108, issue collector 111, issue table database 112, ranking strategy system 113) of the PUIR system 104 may be housed into a single computing device (e.g., a server, a laptop, a desktop, a host device, etc.). However, in other embodiments, some or all of the components of the PUIR system 104 may be included in separate computing device and/or database that are geographically/physically separate from one another, but communicatively coupled via the communication network 120. Similarly, each of the databases (e.g., PUA reports database 109, device profile database 110, issue table database 112) may correspond to its own separate database that is geographically/physically separate from the servers and other databases, but communicatively coupled via the communication network 120.

The communication network 120 may be a public network (e.g., the internet), a private network (e.g., a local area network (LAN) or wide area network (WAN), or a combination thereof. In one embodiment, communication network 120 may include a wired or a wireless infrastructure, which may be provided by one or more wireless communications systems, such as Wi-Fi® connectivity to the communication network 120 and/or a wireless carrier system that can be implemented using various data processing equipment, communication towers (e.g., cell towers), etc. The communication network 120 may carry communications (e.g., data, message, packets, frames, etc.) between any other the computing device.

The PUIR system 104 and client device 102 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

A computing device may be one or more virtual environments. In one embodiment, a virtual environment may be a virtual machine (VM) that may execute on a hypervisor which executes on top of an operating system (OS) for a computing device. The hypervisor may manage system sources (including access to hardware devices, such as processing devices, memories, storage devices). The hypervisor may also emulate the hardware (or other physical resources) which may be used by the VMs to execute software/applications. In another embodiment, a virtual environment may be a container that may execute on a container engine which executes on top of the OS for a computing device. For example, a container engine may allow different containers to share the OS of a computing device (e.g., the OS kernel, binaries, libraries, etc.). A computing device may use the same type or different types of virtual environments. For example, all of the computing devices may be VMs. In another example, all of the computing devices may be containers. In a further example, some of the computing devices may be VMs, other computing device may be containers, and other computing devices may be computing devices (or groups of computing devices).

Although FIG. 1 shows that the PUIR system 104 executes in a cloud-like configuration, in that it sits outside of the organization network 101 and is communicatively coupled to the organization network 101 via a communication network 120, the PUIR system 104 may be implemented in other arrangements. That is, in some embodiments, the PUIR system 104 may execute in local configuration, where the PUIR system 104 executes on a computing device that resides within the organization network 101. Alternatively, in some embodiments, the PUIR system 104 may be mounted (e.g., attached) on or inside a vehicle, such as an automotive vehicle, a marine vehicle, a railed vehicle, or an aircraft vehicle. In this embodiment, the PUIR system 104 may be configured to monitor Functional Safety (FuSa) applications that provide a critical service (e.g., breaking service, acceleration service, steering service) to the vehicle that could impact a safety of a passenger of the vehicle; and/or non-FuSa applications that provide non-critical services (e.g., navigation service, car audio/infotainment service, interior climate control service).

Still referring to FIG. 1, the PUIR agent 106 receives a request (shown in FIG. 1 as ranking request) from an admin device 105, where the request is for the PUIR system 104 to make predictions about whether an upgrade or downgrade to a computer program (e.g., operating system 103) running on a set of client devices 102 in the organization network 101 is likely to create issues impacting the performance of the computing resources (e.g., hardware, software) of the set of client device 102. The ranking request includes a particular version number (e.g., v1, v2, v3) of the computer program that the administrator wants to install on a set of client device 102, along with the device identifiers for the set of client device 102. The PUIR agent 106 forwards the request to the pre-update issue analyzer 108.

The pre-update issue analyzer 108 retrieves the device profile mappings for the set of client devices 102 from the device profile database 110. The pre-update issue analyzer 108 generates, based on the device profile mappings and the information in the request, a plurality of PUA reports indicating a plurality of issues associated with the update of the plurality of software applications executing on the set of client devices 102 to the particular version, but prior to performing the update. For example, a first PUA report may indicate a first set of issues that could be caused by installing the particular version of the software application on a first client device 102 and a second PUA report may indicate a second set of issues that could be caused by installing the particular version of the software application on a second client device 102. The pre-update issue analyzer 108 stores the UA reports in the PUA reports database 109 and sends the PUA reports to the issue collector 111.

The issue collector 111 generates a hash table that includes the content of the plurality of PUA reports and sends the hash table to the ranking strategy system 113. The ranking strategy system 113 generates, based on the hash table, a plurality of scores that each indicate a level of impact that an issue has on the corresponding client device 102, and provides the plurality of scores to the issue ranker 107. The issue ranker 107 ranks (e.g., sorts) the plurality of scores from high to low and generates a report that includes the ranked plurality of scores per issue. The ranking strategy system 113 sends the issue report to the PUI agent 106, which sends the issue report to the admin device 105.

The admin device 105 may be configured to generate a first set of instructions for mitigating and/or resolving the issues, as indicated in the issue report. The admin device 105 may be configured to send the first set of instructions to the PUIR agent 106 to cause the PUIR agent to implement the instructions for mitigating and/or resolving the issues. The admin device 105 may be configured to send, to the PUIR agent 106, a second set of instructions to cause the PUIR agent 106 to perform the update on the plurality of client devices 102 after mitigating and/or resolving the issues. Furthermore, the admin device 105 may be configured to indicate in the second set of instructions to abstain from performing the update on a particular client device 102 if the issues, according to a subsequent issue report, on the particular client device 102 could not be mitigated and/or resolved by the first set of instructions.

Although FIG. 1 shows only a select number of computing devices (e.g., PUIR system 104, client devices 102); the environment 100 may include any number of computing devices that are interconnected in any arrangement to facilitate the exchange of data between the computing devices.

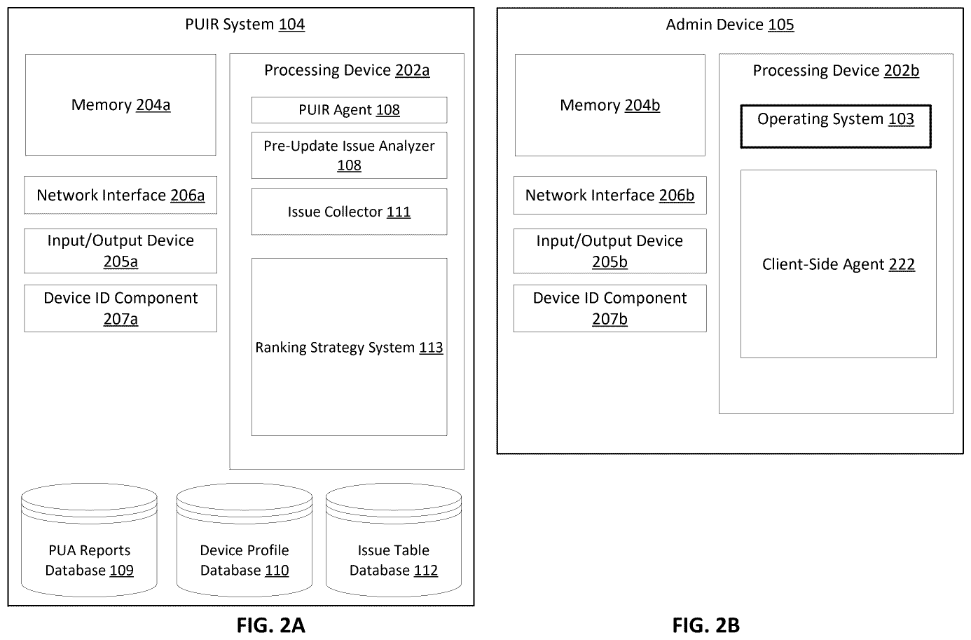

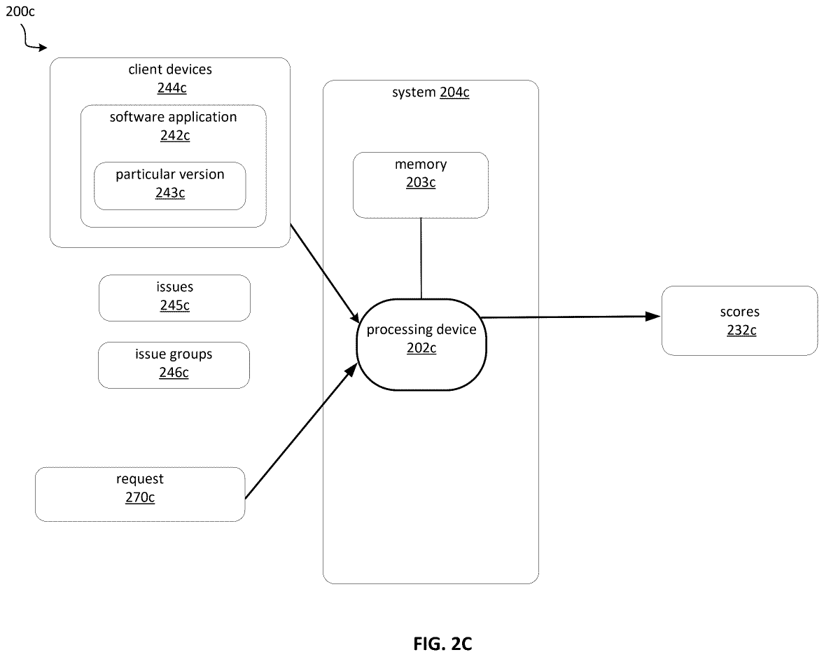

FIG. 2A is a block diagram depicting an example of the pre-upgrade issue ranking (PUIR) system of the environment in FIG. 1, according to some embodiments. While various devices, interfaces, and logic with particular functionality are shown, it should be understood that the PUIR system 104 includes any number of devices and/or components, interfaces, and logic for facilitating the functions described herein. For example, the activities of multiple devices may be combined as a single device and implemented on a same processing device (e.g., processing device 202a), as additional devices and/or components with additional functionality are included.

The PUIR system 104 includes a processing device 202a (e.g., general purpose processor, a PLD, etc.), which may be composed of one or more processors, and a memory 204a (e.g., synchronous dynamic random-access memory (DRAM), read-only memory (ROM)), which may communicate with each other via a bus (not shown).

The processing device 202a may be provided by one or more general-purpose processing devices such as a microprocessor, central processing unit, or the like. In some embodiments, processing device 202a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 202a may include one or more special-purpose processing devices such as an application specific integrated circuit (ASIC), a field programmable gate array (FPGA), a digital signal processor (DSP), network processor, or the like. The processing device 202a may be configured to execute the operations described herein, in accordance with one or more aspects of the present disclosure, for performing the operations and steps discussed herein.

The memory 204a (e.g., Random Access Memory (RAM), Read-Only Memory (ROM), Non-volatile RAM (NVRAM), Flash Memory, hard disk storage, optical media, etc.) of processing device 202a stores data and/or computer instructions/code for facilitating at least some of the various processes described herein. The memory 204a includes tangible, non-transient volatile memory, or non-volatile memory. The memory 204a stores programming logic (e.g., instructions/code) that, when executed by the processing device 202a, controls the operations of the PUIR system 104. In some embodiments, the processing device 202a and the memory 204a form various processing devices and/or circuits described with respect to the PUIR system 104. The instructions include code from any suitable computer programming language such as, but not limited to, C, C++, C #, Java, JavaScript, VBScript, Perl, HTML, XML, Python, TCL, and Basic.

The processing device 202a executes and/or includes PUIR agent 106, a pre-update issue analyzer 108, an issue collector 111, and a ranking strategy system 113. The PUIR system 104 includes a PUIR reports database 109, a device profile database 110, and an issue table database 112.

The PUIR agent 106 receives a request for information indicating an updatability of a plurality of software applications executing on a plurality of client devices to a particular version and forwards the request to the pre-update issue analyzer 108. The pre-update issue analyzer 108 predicts a plurality of issues associated with an update of the plurality of software applications to the particular version prior to performing the update. The ranking strategy system 113 classifies the plurality of issues into a plurality of issue groups. The ranking strategy system 113 generates a plurality of scores respectively associated with the plurality of issue groups. The ranking strategy system 113 ranks the plurality of issue groups based on the plurality of scores.

The pre-update issue analyzer 108 predicts the plurality of issues by obtaining a plurality of device profiles indicating computing resources of the plurality of client devices; and generating, based on the plurality of device profiles, a plurality of reports respectively associated with the plurality of client devices, each report indicating one or more issues associated with the upgrade of the respective software application executing on the respective client device. The pre-update issue analyzer 108 generates a single report from the plurality of reports.

In some embodiments, a first report of the plurality of reports indicates that updating an operating system executing on a first client device of the plurality of client devices to the particular version would create issues for an application executing within the operating system.

The ranking strategy system 113 generates the plurality of scores respectively associated with the plurality of issue groups by detecting, from the plurality of issues and based on a first ranking engine, a first set of issues associated with a first issue group; generating a first set of scores based on the first set of issues; detecting, from the plurality of issues and based on a second ranking engine, a second set of issues associated with a second issue group; and generating a second set of scores based on the second set of issues.

The ranking strategy system 113 generates a first single score by combining the first set of scores; and generating a second single score by combining the second set of scores.

The PUIR agent 106 adjusts the automotive ASIL engine 115 to detect issues related to automotive Automotive Safety Integrity Level (ASIL). The PUIR agent 106 adjusts the security impact engine 116 to detect issues related to security risks. The PUIR agent 106 adjusts the network demand engine 117 to detect issues related to network risks. The PUIR agent 106 adjust the hardware availability engine 118 to detect issues related to hardware risks.

The PUIR agent 106 receives, from the admin device 105, instructions to deploy a custom ranking engine. The PUIR agent 106 generates a custom engine 119 to detect custom issues indicated in the instructions. The ranking strategy system 113 detects, from the plurality of issues and based on the custom engine 119, a third set of issues associated with a third issue group.

The PUIR agent 106 performs the update by upgrading a first software application executing on a first client device from a first version to the particular version and downgrading a second software application executing on a second client device from a third version to the particular version.

The PUIR agent 106 sends, to the admin device 105, a report (e.g., issue report) indicating the ranking of the plurality of issue groups.

The PUIR system 104 includes a network interface 206a configured to establish a communication session with a computing device for sending and receiving data over the communication network 120 to the computing device. Accordingly, the network interface 206a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the PUIR system 104 includes a plurality of network interfaces 206a of different types, allowing for connections to a variety of networks, such as local area networks (public or private) or wide area networks including the Internet, via different sub-networks.

The PUIR system 104 includes an input/output device 205a configured to receive user input from and provide information to a user. In this regard, the input/output device 205a is structured to exchange data, communications, instructions, etc. with an input/output component of the PUIR system 104. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the PUIR system 104, such as a built-in display, touch screen, microphone, etc., or external to the housing of PUIR system 104, such as a monitor connected to PUIR system 104, a speaker connected to PUIR system 104, etc., according to various embodiments. In some embodiments, the PUIR system 104 includes communication circuitry for facilitating the exchange of data, values, messages, and the like between the input/output device 205a and the components of the PUIR system 104. In some embodiments, the input/output device 205a includes machine-readable media for facilitating the exchange of information between the input/output device 205a and the components of the PUIR system 104. In still another embodiment, the input/output device 205a includes any combination of hardware components (e.g., a touchscreen), communication circuitry, and machine-readable media.

The PUIR system 104 includes a device identification component 207a (shown in FIG. 2A as device ID component 207a) configured to generate and/or manage a device identifier associated with the PUIR system 104. The device identifier may include any type and form of identification used to distinguish the PUIR system 104 from other computing devices. In some embodiments, to preserve privacy, the device identifier may be cryptographically generated, encrypted, or otherwise obfuscated by any device and/or component of PUIR system 104. In some embodiments, the PUIR system 104 may include the device identifier in any communication (e.g., issue report, etc.) that the PUIR system 104 sends to a computing device.

The PUIR system 104 includes a bus (not shown), such as an address/data bus or other communication mechanism for communicating information, which interconnects the devices and/or components of PUIR system 104, such as processing device 202a, network interface 206a, input/output device 205a, and device ID component 207a.

In some embodiments, some or all of the devices and/or components of PUIR system 104 may be implemented with the processing device 202a. For example, the PUIR system 104 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 2B is a block diagram depicting an example of an admin device in FIG. 1, according to some embodiments. While various devices, interfaces, and logic with particular functionality are shown, it should be understood that the client device 102 includes any number of devices and/or components, interfaces, and logic for facilitating the functions described herein. For example, the activities of multiple devices may be combined as a single device and implemented on a same processing device (e.g., processing device 202b), as additional devices and/or components with additional functionality are included.

The client device 102 includes a processing device 202b (e.g., general purpose processor, a PLD, etc.), which may be composed of one or more processors, and a memory 204b (e.g., synchronous dynamic random-access memory (DRAM), read-only memory (ROM)), which may communicate with each other via a bus (not shown). The processing device 202b includes identical or nearly identical functionality as processing device 202a in FIG. 2A, but with respect to devices and/or components of the client device 102 instead of devices and/or components of the PUIR system 104.

The memory 204b of processing device 204b stores data and/or computer instructions/code for facilitating at least some of the various processes described herein. The memory 204b includes identical or nearly identical functionality as memory 204a in FIG. 2A, but with respect to devices and/or components of the client device 102 instead of devices and/or components of the PUIR system 104.

The processing device 202b may be configured to execute a client-side agent 219 that sends a request to the PUIR system 104 for information indicating an updatability of a plurality of software applications executing on a plurality of client devices 102 to a particular version. The client-side agent 219 may be configured to receive a report from the PUIR system 104, where the report indicates a ranking of the plurality of issues and issue groups. The client-side agent 219 may be configured to generate a first set of instructions for mitigating and/or resolving the issues of the issue groups. The client-side agent 219 may be configured to send the first set of instructions to the PUIR agent 106 to cause the PUIR agent to implement the instructions for mitigating and/or resolving the issues. The client-side agent 219 may be configured to send, to the PUIR agent 106, a second set of instructions to cause the PUIR agent 106 to perform the update on the plurality of client devices after mitigating and/or resolving the issues. In some embodiments, the client-side agent 219 may indicate in the second set of instructions to abstain from performing the update on a particular client device 102 if the issues on the particular client device 102 could not be mitigated and/or resolved by the first set of instructions.

The client device 102 includes a network interface 206b configured to establish a communication session with a computing device for sending and receiving data over a network to the computing device. Accordingly, the network interface 206b includes identical or nearly identical functionality as network interface 206a in FIG. 2A, but with respect to devices and/or components of the client device 102 instead of devices and/or components of the PUIR system 104.

The client device 102 includes an input/output device 205b configured to receive user input from and provide information to a user. In this regard, the input/output device 205b is structured to exchange data, communications, instructions, etc. with an input/output component of the client device 102. The input/output device 205b includes identical or nearly identical functionality as input/output device 205a in FIG. 2A, but with respect to devices and/or components of the client device 102 instead of devices and/or components of the PUIR system 104.

The client device 102 includes a device identification component 207b (shown in FIG. 2B as device ID component 207b) configured to generate and/or manage a device identifier associated with the client device 102. The device ID component 207b includes identical or nearly identical functionality as device ID component 207a in FIG. 2A, but with respect to devices and/or components of the client device 102 instead of devices and/or components of the PUIR system 104.

The client device 102 includes a bus (not shown), such as an address/data bus or other communication mechanism for communicating information, which interconnects the devices and/or components of the client device 102, such as processing device 202b, network interface 206b, input/output device 205b, and device ID component 207b.

In some embodiments, some or all of the devices and/or components of client device 102 may be implemented with the processing device 202b. For example, the client device 102 may be implemented as a software application stored within the memory 204b and executed by the processing device 202b. Accordingly, such embodiment can be implemented with minimal or no additional hardware costs. In some embodiments, any of these above-recited devices and/or components rely on dedicated hardware specifically configured for performing operations of the devices and/or components.

FIG. 2C is a block diagram depicting an example environment for using the PUIR system in FIG. 1, according to some embodiments. The system 204c (e.g., PUIR system 104 in FIG. 1) includes a memory 203c and a processing device 202c that is operatively coupled to the memory 203c. The processing device 202c is configured to receive a request 270c for information indicating an updatability of a plurality of software applications 242c executing on a plurality of client devices 244c to a particular version 243c. The processing device 202c is configured to predict a plurality of issues 245c associated with an update of the plurality of software applications 242c to the particular version 243c prior to performing the update. The processing device 202c is configured to classify the plurality of issues 245c into a plurality of issue groups 246c. The processing device 202c is configured to generate a plurality of scores 232c respectively associated with the plurality of issue groups 246c. The processing device 202c is configured to rank the plurality of issue groups 246c based on the plurality of scores 232c.

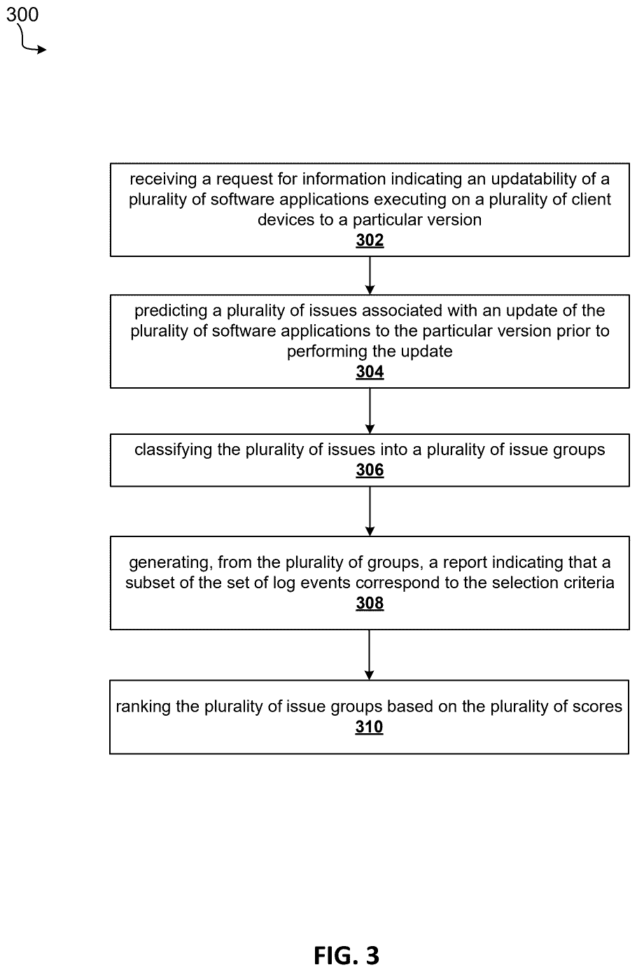

FIG. 3 is a flow diagram depicting a method of intelligently predicting and ranking pre-update issues associated with downgrading or upgrading computer programs at scale, according to some embodiments. Method 300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 300 may be performed by one or more pre-upgrade issue ranking, such as PUIR system 104 in FIG. 1.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

As shown in FIG. 3, the method 300 includes the block 302 of receiving a request for information indicating an updatability of a plurality of software applications executing on a plurality of client devices to a particular version. The method 300 includes the block 304 of predicting a plurality of issues associated with an update of the plurality of software applications to the particular version prior to performing the update. The method 300 includes the block 306 of classifying the plurality of issues into a plurality of issue groups. The method 300 includes the block 308 of generating a plurality of scores respectively associated with the plurality of issue groups. The method 300 includes the block 310 of ranking the plurality of issue groups based on the plurality of scores.

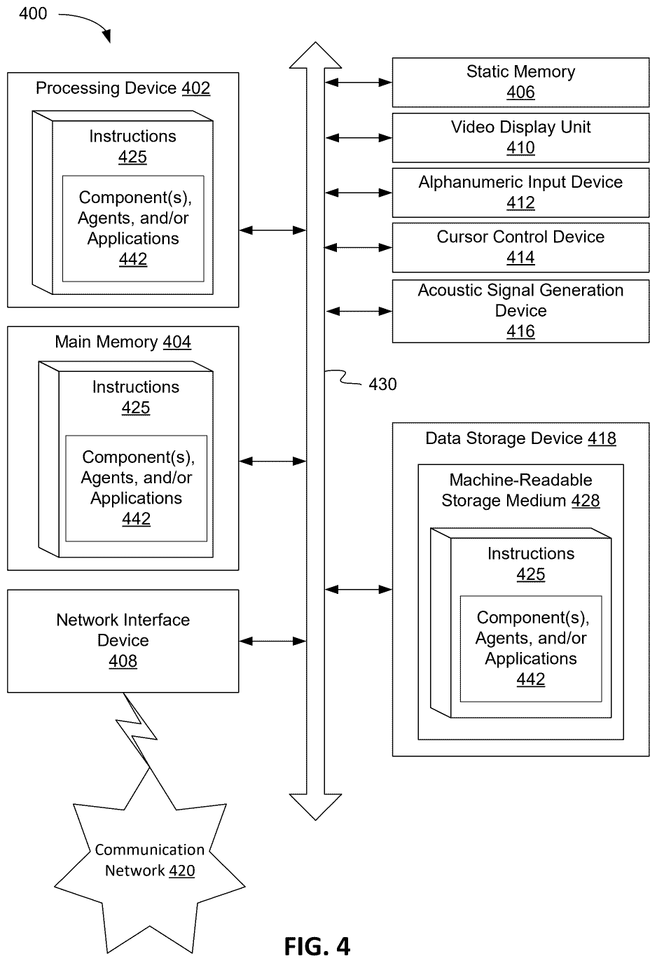

FIG. 4 is a block diagram of an example computing device that may perform one or more of the operations described herein, in accordance with some embodiments. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 400 may include a processing device (e.g., a general-purpose processor, a PLD, etc.) 402, a main memory 404 (e.g., synchronous dynamic random-access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may further include a network interface device 408 which may communicate with a communication network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and an acoustic signal generation device 416 (e.g., a speaker). In one embodiment, video display unit 410, alphanumeric input device 412, and cursor control device 414 may be combined into a single component or device (e.g., an LCD touch screen).

Data storage device 418 may include a computer-readable storage medium 428 on which may be stored one or more sets of instructions 425 that may include instructions for one or more components/programs/applications 442 (e.g., pre-update issue analyzer 108, issue collector 111, ranking strategy system 113, etc.) for carrying out the operations described herein, in accordance with one or more aspects of the present disclosure. Instructions 425 may also reside, completely or at least partially, within main memory 404 and/or within processing device 402 during execution thereof by computing device 400, main memory 404 and processing device 402 also constituting computer-readable media. The instructions 425 may further be transmitted or received over a communication network 420 via network interface device 408.

While computer-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “predicting,” “classifying,” “generating,” “ranking,” “obtaining,” “detecting,” “adjusting,” “performing,” “sending,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112(f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

What is claimed is:

1. A method of comprising:
receiving a request for information indicating an updatability of a plurality of software applications executing on a plurality of client devices to a particular version;
predicting a plurality of issues associated with an update of the plurality of software applications to the particular version prior to performing the update;
classifying the plurality of issues into a plurality of issue groups;
generating, by a processing device, a plurality of scores respectively associated with the plurality of issue groups; and
ranking the plurality of issue groups based on the plurality of scores.

2. The method of claim 1, wherein predicting the plurality of issues associated with the update of the plurality of software applications to the particular version further comprises:
obtaining a plurality of device profiles indicating computing resources of the plurality of client devices; and
generating, based on the plurality of device profiles, a plurality of reports respectively associated with the plurality of client devices, each report indicating one or more issues associated with the upgrade of the respective software application executing on the respective client device.

3. The method of claim 2, further comprising:
generating a single report from the plurality of reports.

4. The method of claim 2, wherein a first report of the plurality of reports indicates that updating an operating system executing on a first client device of the plurality of client devices to the particular version would create issues for an application executing within the operating system.

5. The method of claim 1, wherein generating the plurality of scores respectively associated with the plurality of issue groups further comprises:
detecting, from the plurality of issues and based on a first ranking engine, a first set of issues associated with a first issue group;
generating a first set of scores based on the first set of issues;
detecting, from the plurality of issues and based on a second ranking engine, a second set of issues associated with a second issue group; and
generating a second set of scores based on the second set of issues.

6. The method of claim 5, further comprising:
generating a first single score by combining the first set of scores; and
generating a second single score by combining the second set of scores.

7. The method of claim 5, further comprising:
adjusting the first ranking engine to detect issues related to automotive Automotive Safety Integrity Level (ASIL);
adjusting the first ranking engine to detect issues related to security risks;
adjusting the first ranking engine to detect issues related to network risks; or
adjusting the first ranking engine to detect issues related to hardware risks.

8. The method of claim 5, wherein the plurality of client devices executes within a computing network, and further comprising:
receiving, from an administrator device executing within the computing network, instructions to deploy a custom ranking engine; and
detecting, from the plurality of issues and based on the custom ranking engine, a third set of issues associated with a third issue group.

9. The method of claim 1, further comprising:
performing the update by upgrading a first software application executing on a first client device from a first version to the particular version and downgrading a second software application executing on a second client device from a third version to the particular version.

10. The method of claim 1, wherein the plurality of client devices executes within a computing network, and further comprising:
sending, to an administrator device executing within the computing network, a report indicating the ranking of the plurality of issue groups.

11. A system comprising:
a memory; and
a processing device, operatively coupled to the memory, to:
receive a request for information indicating an updatability of a plurality of software applications executing on a plurality of client devices to a particular version;
predict a plurality of issues associated with an update of the plurality of software applications to the particular version prior to performing the update;
classify the plurality of issues into a plurality of issue groups;
generate a plurality of scores respectively associated with the plurality of issue groups; and
rank the plurality of issue groups based on the plurality of scores.

12. The system of claim 11, wherein to predict the plurality of issues associated with the update of the plurality of software applications to the particular version, the processing device is further to:
obtain a plurality of device profiles indicating computing resources of the plurality of client devices; and
generate, based on the plurality of device profiles, a plurality of reports respectively associated with the plurality of client devices, each report indicating one or more issues associated with the upgrade of the respective software application executing on the respective client device.

13. The system of claim 11, wherein the processing device is further to:
generate a single report from the plurality of reports.

14. The system of claim 11, wherein a first report of the plurality of reports indicates that updating an operating system executing on a first client device of the plurality of client devices to the particular version would create issues for an application executing within the operating system.

15. The system of claim 11, wherein to generate the plurality of scores respectively associated with the plurality of issue groups, the processing device is further to:
detect, from the plurality of issues and based on a first ranking engine, a first set of issues associated with a first issue group;
generate a first set of scores based on the first set of issues;
detect, from the plurality of issues and based on a second ranking engine, a second set of issues associated with a second issue group; and
generate a second set of scores based on the second set of issues.

16. The system of claim 11, wherein the processing device is further to:
generate a first single score by combining the first set of scores; and
generate a second single score by combining the second set of scores.

17. The system of claim 11, wherein the processing device is further to:
adjust the first ranking engine to detect issues related to automotive Automotive Safety Integrity Level (ASIL);
adjust the first ranking engine to detect issues related to security risks;
adjust the first ranking engine to detect issues related to network risks; and
adjust the first ranking engine to detect issues related to hardware risks.

18. The system of claim 11, wherein the plurality of client devices executes within a computing network, and wherein the processing device is further to:
receive, from an administrator device executing within the computing network, instructions to deploy a custom ranking engine; and
detect, from the plurality of issues and based on the custom ranking engine, a third set of issues associated with a third issue group.

19. The system of claim 11, wherein the processing device is further to:
perform the update by upgrading a first software application executing on a first client device from a first version to the particular version and downgrading a second software application executing on a second client device from a third version to the particular version.

20. A non-transitory computer-readable medium storing instructions that, when executed by a processing device, cause the processing device to:
receive a request for information indicating an updatability of a plurality of software applications executing on a plurality of client devices to a particular version;
predict a plurality of issues associated with an update of the plurality of software applications to the particular version prior to performing the update;
classify the plurality of issues into a plurality of issue groups;
generate, by the processing device, a plurality of scores respectively associated with the plurality of issue groups; and
rank the plurality of issue groups based on the plurality of scores.
